(19) United States
(12) Patent Application Publication
(10) Pub. No.: US 2009/0119971 A1
(43) Pub. Date: May 14, 2009

(54) FISHING LURE HEAD

(76) Inventors: Steven H. MIYASATO, Pearl City, HI (US); Bert M. Miyasato, Pearl City, HI (US)

Correspondence Address: Leighton K. Chong;Patent Attorney, 133 Kaai Street, Honolulu, HI, 96821, US

(21) Appl. No.: 11/938,202

(22) Filed: Nov. 9, 2007

(51) Int. Cl. A01K 85/00

(52) U.S. Cl. 43/42.39; 43/42.36; 43/42.24

(57) ABSTRACT

An improved fishing lure head has an outer shell with a smooth, curved outer surface and a through-hole for passing a leader line therethrough, an interior that is hollow, and a rearward open end leading into a cavity which provides a volume for holding a leading end of a soft plastic lure therein. Preferably, the front end of the shell has a weighted portion with a hole or aperture for passing the leader line therethrough. A soft plastic lure is threaded on a hook and leader line and pulled into the cavity of the shell where it is strongly held by suction forces created by press fitting into the cavity. Retention of the lure in the cavity may be further reinforced by providing a retainer ring at the rearward open end of the shell.

This invention relates to fishing lure heads, and more particularly, to a jig head which has means for retaining a soft plastic lure on a hook through strong casting, retrieving, and trolling drag forces.

### BACKGROUND OF INVENTION

A wide variety of artificial lures are used by sports fishermen. Artificial fishing lures are commonly used with a “jig” which is a combination of a hook and a weighted jig head made of a heavy material such as lead for weighting the lure down to fishing depths in the water. Typically, the jig head has an eye or a portion of the hook's shank extends through the jig head so that the eye of the hook protrudes from the jig head in order to attach it to the fishing line. A lure for fish is typically attached to the end of the jig or skewered onto the hook, and is constructed of materials such as fibers, rubber or plastic appendages to resemble bait that is attractive to fish in the water.

Weighted jig heads and hooks may be formed in a variety of configurations. One common jig configuration has a weighted jig head that is elongated in shape and used with a hook having a straight shank. An eye is positioned or extends from a front portion of the jig head while the hook shank extends from the rear of the jig head. The typical metal jig head comes with a molded-in hook. Fishermen use this type of jig for casting and intermittently retrieving the jig to allow it to sink in the water so that it travels in a zig-zag fashion at the intended depth for fishing.

Soft plastic lures commonly used for bait are made from a soft, flexible plastic called plastisol. The plastisol is readily processed and cured in a mold to produce soft plastic fishing lures in different shapes and colors. In its cured form, the plastisol is very flexible and pliable which allows it to wiggle or move in the water in ways that are attractive as bait to fish. However, it is also easy to cut and tear, does not reseal itself when damaged. Fishermen like to select the plastic lures of shapes, colors, and movement characteristics that they believe are most attractive to fish. The plastisol lures are baited on the hook by skewering the sharp barbed point of the hook into the plastisol lure and pushing it lengthwise along the shank of the hook so that the body of the lure is positioned high on the hook shank with the hook barb extending from the rear portion.

An inherent problem with retaining a lure on the jig head or on the hook is the strong drag forces exerted by water flow around the jig head due to boat towing forces and forces of reeling in the fishing line. For a plastisol lure that has been skewered on a hook, the water drag forces often can displace the lure so that it becomes bunch in an unattractive way on the hook or can tear the lure off the hook. In this way, plastisol lures are commonly torn from hooks during casting and retrieving, requiring the fishermen to continually check and rebait them, and also wasting large numbers of such lures.

### SUMMARY OF INVENTION

In accordance with the present invention, an improved fishing lure head has an outer shell with a smooth, curved outer surface on its front end and a through-hole for passing a leader line therethrough, an interior that is hollow, and a rearward open end leading into a cavity which provides a volume for holding a leading end of a soft plastic lure therein. The front end of the shell may hold or have molded therein a weighted portion also having a hole or aperture for passing the leader line therethrough. A leading end of a soft plastic lure is held in the hollow cavity by suction forces created by press fitting it into the cavity. The soft plastic material of the lure tends to elastically deform and mold into the shape of the cavity. The curved side walls of the shell help to compress the soft plastic material of the lure in a press fit that increases the suction effect. Retention of the lure in the cavity may be further reinforced by providing a retainer ring at the rearward open end of the shell.

Rigging of the jig head with a soft plastic lure begins with threading a leader line through the hole in the front end of the jig head and attaching it to the eye of a hook. A soft plastic lure is skewered by its leading end onto the barbed end of the hook and threaded along the leader line toward the rearward open end of the jig head. The body portion of the soft plastic lure is then pushed into the cavity past the retainer ring and press fitted therein against the back surface of the weighted portion of the jig head. The hook is then pulled, by pulling on the leader line, towards the jig head until it passes through the body portion of the soft plastic lure and the eye of the hook becomes stopped by the back surface of the weighted portion.

Other objects, features, and advantages of the present invention will be explained in the following detailed description of the invention having reference to the appended drawings.

### BRIEF DESCRIPTION OF DRAWINGS

FIGS. 1A-1D illustrate the baiting of the hook of a jig and problems of tearing due to water drag forces that occur in the prior art.

FIG. 2A and FIG. 2B show an improvement in fishing lure head design in accordance with the present invention, in side sectional view and rear view, respectively.

FIGS. 3A, 3B, and 3C show the method of rigging a soft plastic lure on the jig head in the present invention.

### DETAILED DESCRIPTION OF INVENTION

In the following detailed description of the invention, certain preferred embodiments are illustrated providing certain specific details of their implementation. However, it will be recognized by one skilled in the art that many other variations and modifications may be made given the disclosed principles of the invention.

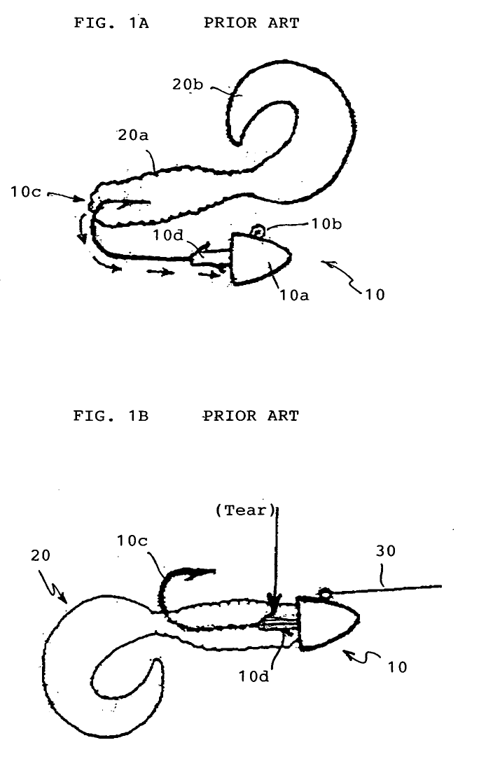

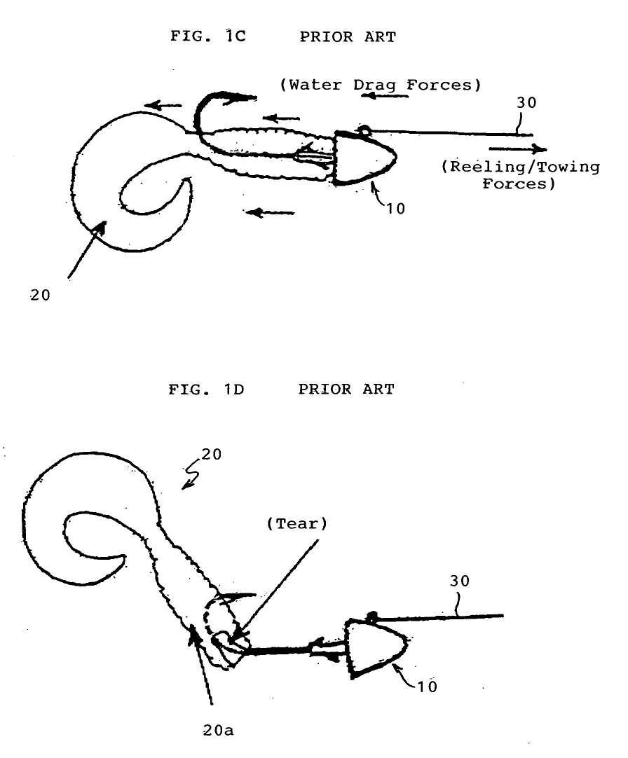

Referring to FIGS. 1A-1D, the problems in the prior art with baiting the hook of a jig and tearing due to water drag forces are illustrated. In FIG. 1A, a jig 10 has a jig head 10a, eye 10b for attaching a fishing line, a hook 10c, and a barbed shank 10d for holding the lure thereon. A typical soft plastic lure is attached onto the hook 10c by skewering through a body portion 20a, with its tail portion 20b intended to remain free to wiggle in the water in a manner attractive to fish. The tip of the hook 10c is inserted into the thickest part of the typical soft plastic lure and then pushed and sewn over the hook and into position on the barbed shank 10d, as shown in FIG. 1B.

During this initial rigging of the soft plastic lure onto the jig head, the soft plastic lure is cut by the hook 10c and may be further damaged by the barbed protrusions on the barbed shank 10d of the jig head 10, resulting in a tear being formed. The barbed shank protrusions are intended to hold the soft plastic lure in position, but often these protrusions initiate a tear leading to the disabling of the soft plastic lure. The soft plastic does not reseal itself after it has been cut or torn. As shown in FIG. 1C, the tension forces on the jig head 10 from casting, retrieval, and/or boat towing on the fishing line 30 results in strong forces applied around the jig head and exerted on the soft plastic lure 20. These forces (energy from casting in the air and water drag forces) take their toll on the already damaged soft plastic lure. There is also drag forces on the lure tail 20b in the water where it is typically designed to wiggle with maximum movement under water drag forces (left arrows in the figure). Tension on the fishing line 30 tends to generate separation forces tending to dislodge the soft plastic lure from the jig head. As shown in FIG. 1D, the soft plastic lure after a short period of time may become forced into an undesirable position down on the hook and/or the previously incurred tear may enlarge and result in the lure being further torn or pulled off the hook. The displaced, damaged, or lost lure must then be reset or replaced.

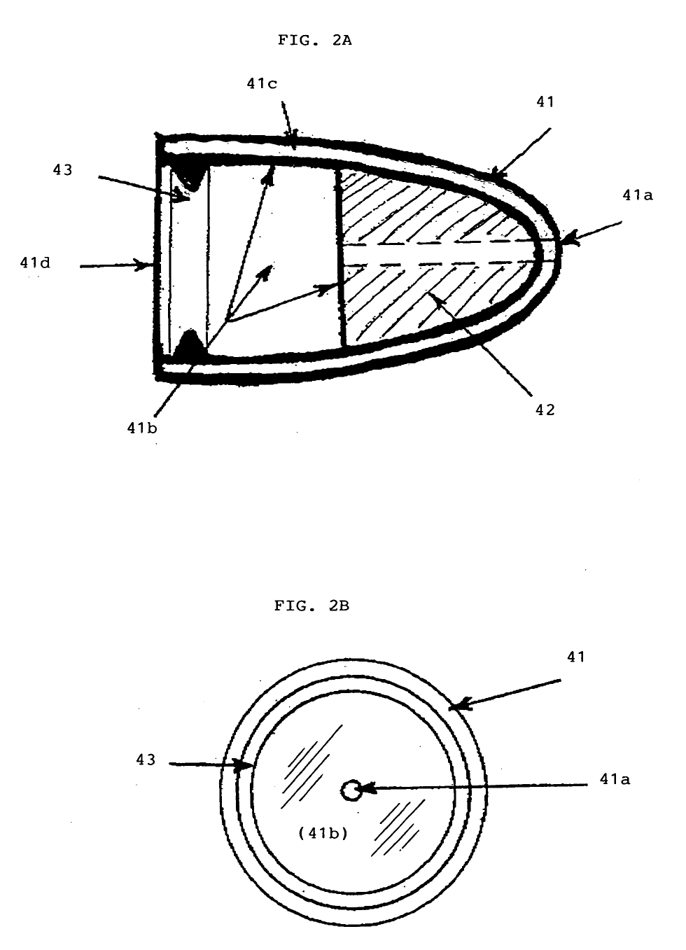

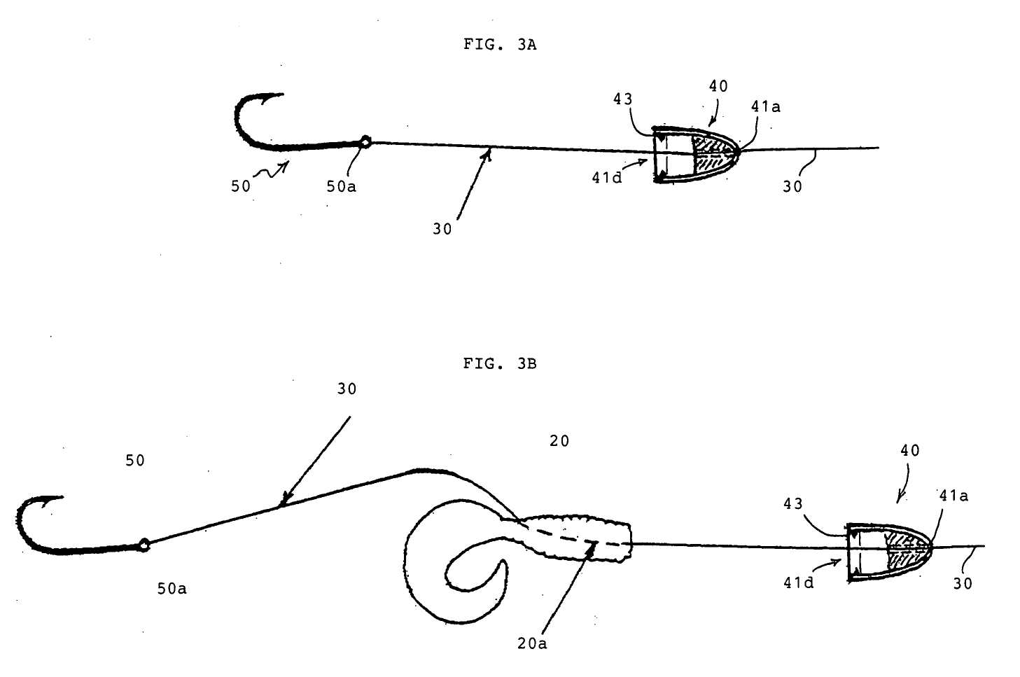

In accordance with the present invention, an improvement in fishing lure head design is shown in side sectional view in FIG. 2A and rear view in FIG. 2B which overcomes the problems produced by conventional jig heads. The improved jig head 40 has an outer shell 41 with a smooth, curved outer surface such as a spherical, oval, or conical shape for low drag and stable movement through the water. The outer shell 41 may be made from any suitable waterproof material such as metal, ceramic, resin, plastic, or wood sealed with a non-porous coating. The front end of the shell is closed except for a through-hole 41a for a leader line to pass through. The interior of the shell 41 is hollow. The front end of the shell 41 may hold or be molded with a weighted portion 42 made of any suitable weighting material. The weighted portion also has a hole or aperture for passing the leader line through. The weighted portion 42 has a back surface with the hole or aperture therethrough having a diameter smaller than the eye of a standard size hook to be used with the jig head, such that the hook when threaded through a soft plastic lure can be pulled into the cavity of the jig head with the hook eye abutting against the back surface of the weighted portion.

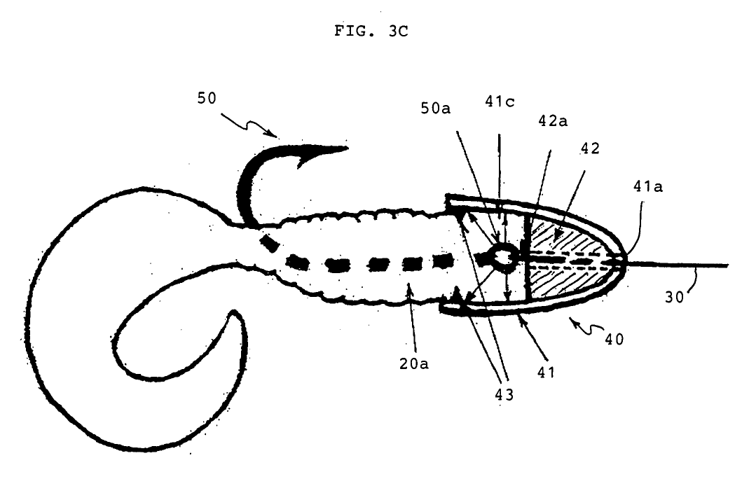

At the back end of the shell 40 is a hollow cavity 41b which provides a volume for pushing the leading end of a soft plastic lure (once skewered on a hook) therein. The soft plastic material of the lure tends to elastically deform and mold into the shape of the cavity 41b and create suction forces that help to retain the leading end of the lure in the cavity. The curved walls of the shell along the sides 41c help to compress the soft plastic material of the lure in a press fit that increases the suction effect. Retention of the lure in the cavity may be further reinforced by providing a retainer ring (“choker”) 43 at the rearward open end 41d of the shell 40. The retainer ring has an inner diameter smaller than the diameter of the rearward open end of the shell for constricting the open end and reinforcing the retention of a soft plastic lure therein Referring to FIGS. 3A and 3B, rigging of the jig head 40 with a soft plastic lure 20 begins with threading a leader line 30 through the hole 41a in the front end of the jig head 40 and attaching it to the eye 50a of a hook 40. A soft plastic lure 20 is selected by the angler and skewered by the leading end of its body portion 20a onto the barbed end of the hook 50 and threaded along the leader line 30 toward the rearward open end 41d of the jig head 40. The body portion 20a of the soft plastic lure is then pushed into the cavity 41b past the retainer ring 43 and press fitted therein against the back surface of the weighted portion 42 of the jig head. The hook 50 is then pulled, by pulling on the leader line 30, towards the jig head 40 until it passes through the body portion 20a of the soft plastic lure press fitted into the cavity 41c of the shell 41, and the eye 50a of the hook becomes stopped by the back surface 42a of the weighted portion 42, as shown in FIG. 3C. The rigged soft plastic lure 20 secured to the jig head 40 is now ready for use in fishing.

The soft plastic lure will be securely retained in the jig head despite strong casting forces and water drag forces. The vacuum created by the body portion 20a of the lure pressing out the air in the cavity 41c in the jig shell generates a strong suction that keeps the body portion snugly in the cavity. Pressure from the hook eye 50a pushes and expands the soft plastic material towards the side walls of the cavity for greater compressive and suction forces. Lateral pressure from the retaining ring 43 helps to keep the body portion of the lure from slipping out from the cavity and keeps the soft plastic lure locked in position. It also prevents the jig head from sliding independently from the soft plastic lure. Tension on the leader line 30 becomes applied by the hook eye 50a against the back surface of the weighted portion 42 at the front end of the jig head, and does not generate separation forces of the jig head from the soft plastic lure as occurs in the conventional jig head arrangement. When tension is applied on the line from casting, retrieval, or towing (trolling), the soft plastic lure is pulled into the cavity, rather than separated from it. The rigged soft plastic lure is able to remain in the desired position indefinitely even during severe fishing conditions. This combination of retention forces ensures that the soft plastic lure will not become dislodged or torn from the jig head and hook as occurs with conventional arrangements.

The following attributes of the improved lure head design are also advantageous to the angler. The angler in now able to interchange hooks of different sizes and styles with the lure head, unlike existing jig heads that have molded-in hooks. The angler now has the ability to fish with the rigged soft plastic lure despite extreme pressures from casting, retrieving, and towing unlike the typical jig heads. The angler can now position the hook point at any position along the length of the soft plastic lure without having to worry about tearing or separation, unlike the molded-in hook of the typical jig head. Also, the soft plastic lure is not extensively damaged during rigging unlike the typical jig head. Due to the strong retention forces created by the lure head configuration, lures of other, less pliable materials than plastisol may be used, such as those made of rubber or other plastic materials.

It is to be understood that many modifications and variations may be devised given the above description of the principles of the invention. It is intended that all such modifications and variations be considered as within the spirit and scope of this invention, as defined in the following claims.

1. An improved fishing lure head comprising:
a conically-shaped outer shell having a smooth, curved walls extending from its front end to its rearward end and a through-hole in the center of its front end for passing a leader line therethrough,
said outer shell having an interior that is hollow and defined as a cavity with curved side walls tapering outwardly from the front end to the rearward end as defined by the curved walls of said outer shell,
a the rearward end of the outer shell having a rearward opening leading into a the cavity formed in the interior of the outer shell, and
a weighted portion having a hole or aperture for passing a leader line therethrough that is inserted into a front end of said cavity, which provides a remaining volume at a back end of the cavity defined by the curved side walls for holding a leading end of a soft plastic lure therein,
wherein, when a leading end of a soft plastic lure skewered on a hook is pushed into said remaining volume at the back end of the cavity defined by said curved side walls thereof, the soft plastic material of the lure tends to elastically deform against the curved side walls thereby helping to compress the soft plastic material of the lure and mold it into the curved shape of the back end of the cavity, in order to create suction forces that help to retain the leading end of the lure in the cavity.

2-3. (canceled)

4. An improved fishing lure head according to claim 1, wherein the weighted portion is molded in the interior of the shell at its front end.

5. (canceled)

6. An improved fishing lure head according to claim 1, wherein the rearward open end of the shell is formed with a retainer ring having an inner diameter smaller than the diameter of the rearward open end of the shell for constricting the open end and reinforcing the retention of a soft plastic lure therein.

7. An improved fishing lure head according to claim 1, wherein the weighted portion has a back surface and the hole or aperture therethrough is of a diameter smaller than the eye of a standard size hook such that the hook-threaded with a leader line through a soft plastic lure can be pulled into the cavity of the shell with the hook eye abutting against the back surface of the weighted portion.

8. An improved fishing lure head combination comprising:
a jig head with a conically-shaped outer shell having a smooth, curved walls extending from its front end to its rearward end and a through-hole in the center of its front end for passing a leader line therethrough,
said outer shell having an interior that is hollow and defined as a cavity with curved side walls tapering outwardly from the front end to the rearward end as defined by the curved walls of said outer shell,
the rearward end of the outer shell having a rearward opening leading into a the cavity formed in the interior of the outer shell,
a weighted portion having a hole or aperture for passing the leader line therethrough that is inserted into a front end of said cavity, which provides a remaining volume at a back end of the cavity defined by the curved side walls for holding a leading end of a soft plastic lure therein, and
a lure having a body portion made of a soft pliable plastic material adapted to be threaded on a standard size hook and leader line and pressed by a leading end thereof into the cavity in the interior of the jig head shell,
wherein, when the leading end of the soft plastic lure skewered on a hook is pushed into said remaining volume at the back end of the cavity defined by said curved side walls thereof, the soft plastic material of the lure tends to elastically deform against the curved side walls thereby helping to compress the soft plastic material of the lure and mold it into the curved shape of the back end of the cavity, in order to create suction forces that help to retain the leading end of the lure in the cavity.

9-10. (canceled)

11. An improved fishing lure head combination according to claim 8, wherein the rearward open end of the shell is formed with a retainer ring having an inner diameter smaller than the diameter of the rearward open end of the shell for constricting the open end and reinforcing the retention of the lure therein.

12. An improved fishing lure head combination according to claim 8, wherein the weighted portion has a back surface and the hole or aperture therethrough is of a diameter smaller than the eye of a standard size hook such that the hook threaded with a leader line through the lure can be pulled into the cavity of the jig head shell with the hook eye abutting against the back surface of the weighted portion.

13. An improved fishing lure head combination according to claim 8, wherein the body portion of the lure is made of a material selected from the group comprising plastisol; rubber; and other plastic material.

14. A method of rigging a lure on a jig head comprising:
providing a jig head with an outer shell having a smooth, curved outer surface on its front end and a through-hole for passing a leader line therethrough, and interior that is hollow, a weighted portion provided at the front end of the jig head shell having a hole or aperture for passing a leader line therethrough, and a rearward open end leading into a cavity formed in the interior of the shell;
threading a lure having a body portion made of a soft pliable material on a standard size hook with an eye attached to a leader line is passed through the hole in the jig head shell; and
pulling the leader line to pull the hook into the cavity of the jig head shell with the hook eye abutting against a back surface of the weighted portion and the body portion of the the lure pressed into the cavity in the interior of the jig head shell.

15. A method of rigging a lure on a jig head according to claim 14, wherein the cavity of the shell is formed with curved side walls that help to compress the soft pliable material of the lure therein.

16. A method of rigging a lure on a jig head according to claim 14, wherein the rearward open end of the shell is formed with a retainer ring having an inner diameter smaller than the diameter of the rearward open end of the shell for constricting the open end and reinforcing the retention of the lure therein.

17. A method of rigging a lure on a jig head according to claim 14, wherein the weighted portion has a back surface and the hole or aperture therethrough is of a diameter smaller than the eye of a standard size book such that the hook threaded with a leader line through the can be pulled into the cavity of the jig head shell with the hook eye abutting against the back surface of the weighted portion.

18. A method of rigging a lure on a jig head according to claim 14, wherein the body portion of the lure is made of a material selected from the group comprising: plastisol; rubber; and other plastic material.

19. A method of rigging a lure on a jig head according to claim 14, wherein the rigged lure is used for casting, retrieving, and trolling for fish.

20. A method of rigging a lure on a jig head according to claim 14, wherein the rigged lure is capable of retaining the lure in the jig head under tension forces and water drag forces due to casting, retrieving, and trolling for fish.
